(19) United States
(12) Patent Application Publication
(10) Pub. No.: US 2007/0216580 A1
(43) Pub. Date: Sep. 20, 2007

(54) Electro-stimulating massage confiner

(75) Inventors: Shun-Tian Lin, Taipei (TW); Chang-Fa Yang, Taipei (TW); Chi-Tzu Liu, Taipei (TW); Kuo-Lun Huang, Taipei (TW); Yen-Ming Chen, Taipei (TW); Chao-Wei Wang, Taipei (TW); Chuan-Lin Hu, Taipei Hsien (TW); Yu-Wei Chen, Taipei Hsien (TW); Chang-Lun Liao, Taipei Hsien (TW)

Correspondence Address: BACON & THOMAS, PLLC, 625 SLATERS LANE, FOURTH FLOOR, ALEXANDRIA, VA, 22314, US

(73) Assignee: CHANT SINCERE CO., LTD., Taipei Hsien (TW)

(21) Appl. No.: 11/374,957

(22) Filed: Mar. 15, 2006

(51) Int. Cl. H01Q 1/24; H01Q 1/42

(52) U.S. Cl. 343/702; 343/700 MS; 343/872

(57) ABSTRACT

A device shell for use in a wireless communication device, is disclosed to have a shell body injection-molded from a compound material in a predetermined shape, and an antenna circuit formed in the shell body and electrically connectable to a circuit board in a wireless communication device in which the device shell is used.

### BACKGROUND OF THE INVENTION

(a) Field of the Invention

The present invention relates to a device shell for wireless communication device and more particularly, to an antenna incorporated device shell, which has an antenna circuit incorporated therein, thereby saving the surface space of the circuit board the wireless communication device.

(b) Description of the Prior Art:

Regular wireless communication devices such as cell phones, PDA, wireless earphones, radios, TVs, and etc. use an internal antenna to receive wireless signal. An antenna for this purpose is usually made in a module and bonded to the circuit board of the wireless communication device. After installation of an antenna module in a circuit board, a free surface space at the circuit board around the antenna module must be maintained for normal performance the antenna module. Therefore, the antenna module of a wireless communication device occupies much surface space of the circuit board. Due to this limitation, conventional wireless communication devices cannot be reduced further in size.

### SUMMARY OF THE INVENTION

The present invention has been accomplished under the circumstances in view. It is one object of the present invention to provide an antenna incorporated device shell, which has the antenna circuit formed integral with the shell body that is injection-molded from polymers, thereby saving much surface space of the circuit board of the wireless communication device. Further, because the antenna circuit is formed integral with the shell body, the shell body protects the antenna circuit against deformation.

It is another object of the present invention to provide an antenna incorporated device shell, which has the antenna circuit directly formed in the shell body and then packaged with a compound material of polymers and dielectric ceramic, enhancing the stability of the performance of the antenna.

It is still another object of the present invention to provide an antenna incorporated device shell, which has the antenna circuit embedded in the shell body, with metal contact pins or springs thereof exposed to the outside of the shell body for contacting respective contacts at the circuit board of the wireless communication device.

It is still another object of the present invention to provide an antenna incorporated device shell, which has the antenna circuit formed in the shell body in a smooth, curved, three-dimensional or any of a variety of irregular shapes subject to the configuration of the shell body.

It is still another object of the present invention to provide an antenna incorporated device shell, which has the antenna circuit directly formed in the shell body by molding or insert molding.

It is still another object of the present invention to provide an antenna incorporated device shell, which has the antenna circuit formed in a ceramic substrate, polymer substrate, or ceramic and polymer compound substrate, and then bonded to the shell body by molding or insert molding.

It is still another object of the present invention to provide an antenna incorporated device shell, which has the antenna circuit formed in the shell body by: screen-printing or spray-coating a conducting compound material of polymer and metal on the surface of the shell body and then employing an electroplating or electroforming technique to form the designed antenna circuit.

It is still another object of the present invention to provide an antenna incorporated device shell, which has the antenna circuit formed in the shell body by electroplating or electroforming subject to the application of a masking technique.

It is still another object of the present invention to provide an antenna incorporated device shell, which has an antenna circuit bonding member molded from a conducting polymer or polymer and metal compound on the shell body that is molded from polymer, subject to the configuration of the shell body, and has the designed antenna circuit form in the antenna circuit bonding member, and then has a packaging layer bonded to the shell body and covered over the antenna circuit and the antenna circuit bonding member.

### BRIEF DESCRIPTION OF THE DRAWINGS

FIG. 1 is an exploded view of an antenna incorporated device shell according to one embodiment of the present invention.

FIG. 2 is a schematic assembly view of FIG. 1.

FIG. 3 is a cross sectional view of the present invention, showing the antenna circuit formed in the shell body in flush with the outer surface of the shell body.

FIG. 4 is a cross sectional view of an alternate form of the present invention, showing the antenna circuit embedded in the shell body.

FIG. 5 is a cross sectional view of another alternate form of the present invention, showing the antenna circuit formed in the shell body in flush with the inner surface of the shell body.

FIG. 6 is a schematic sectional view showing the metal contact pin of the antenna circuit disposed in contact with the circuit board according to the present invention.

FIG. 7 is a schematic sectional view of the metal contact spring of the antenna circuit disposed in contact with the circuit board according to the present invention.

FIG. 8 is a schematic drawing showing an antenna circuit bonding member molded in the shell body in a flush manner according to the present invention.

FIG. 9 corresponds to FIG. 8, showing the antenna circuit formed in the antenna circuit bonding member.

FIG. 10 is a schematic drawing showing an antenna circuit bonding member molded in the shell body in a flush manner according to the present invention.

FIG. 11 corresponds to FIG. 10, showing the antenna circuit formed in the antenna circuit bonding member.

FIG. 12 corresponds to FIG. 11, showing a packaging layer bonded to the shell body and covered on the antenna circuit and the antenna circuit bonding member.

FIG. 13 is a sectional view showing the antenna circuit embedded in the shell body in a curved configuration.

### DETAILED DESCRIPTION OF THE PREFERRED EMBODIMENTS

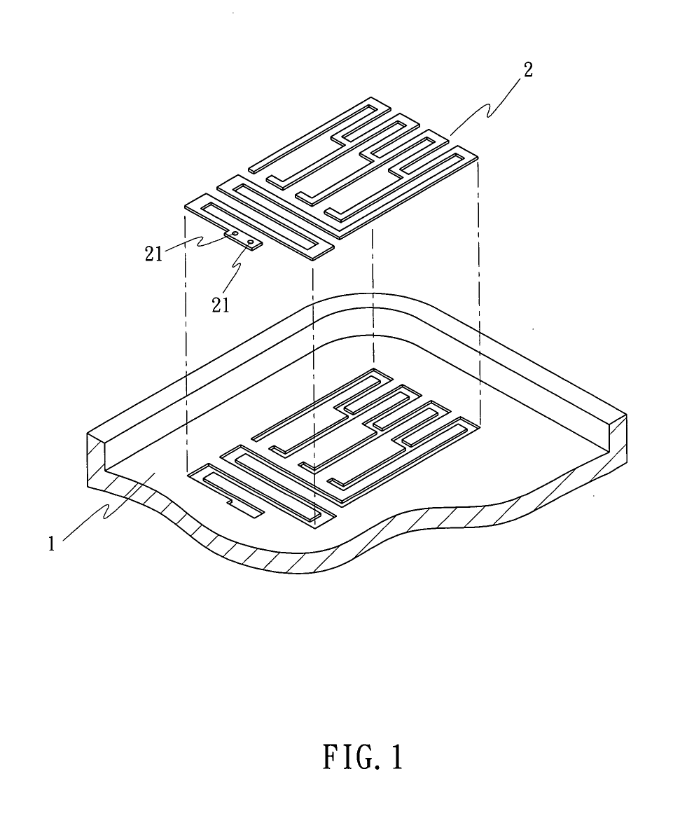

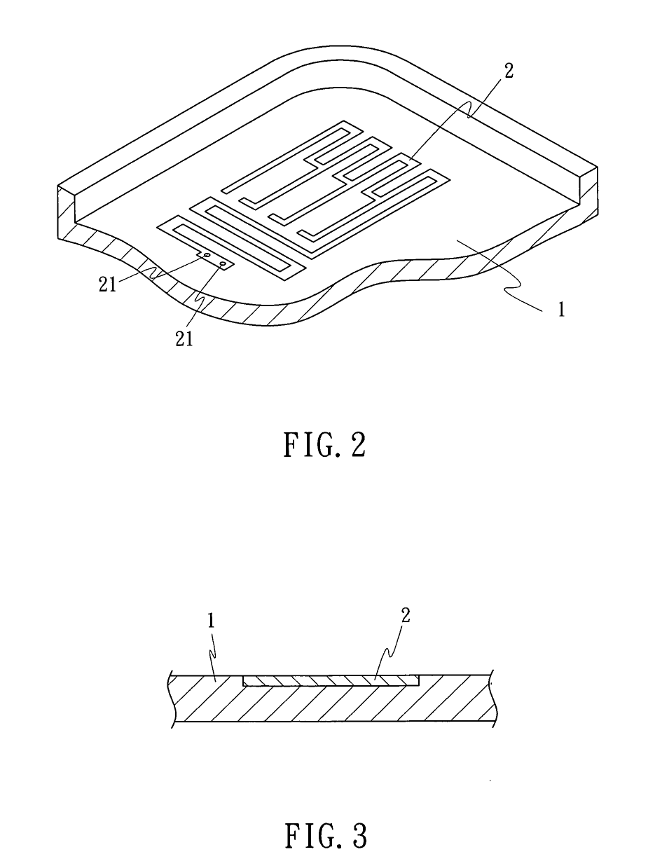

Referring to FIGS. 1 and 2, an antenna incorporated device shell in accordance with the present invention is shown comprised of a shell body 1, and at least one antenna circuit 2.

The shell body 1 is injection molded from polymers in a predetermined shape subject to the wireless communication device for which the shell body 1 is used. Further, the shell body 1 can be made having a smooth, curved, or three-dimensional outer appearance.

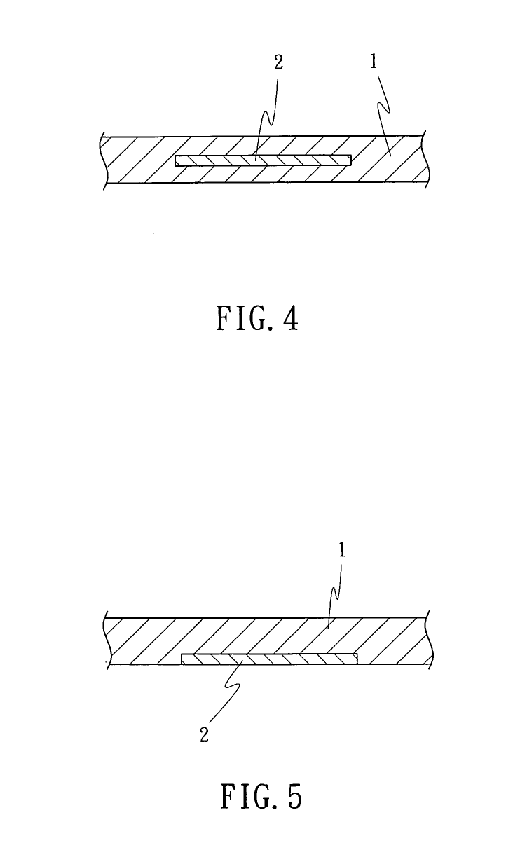

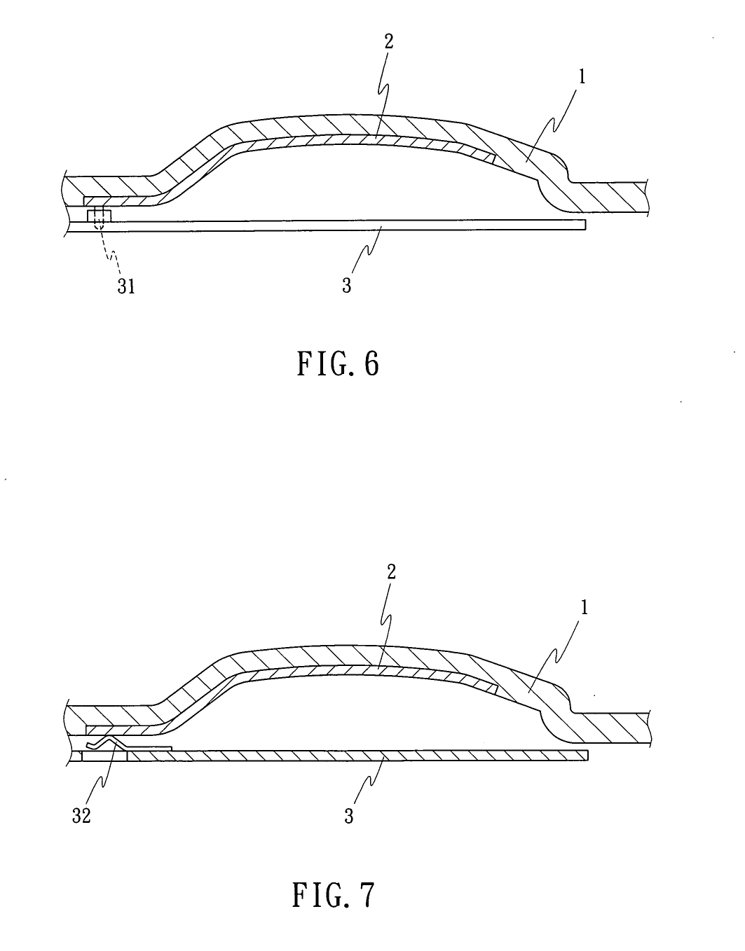

The antenna circuit 2 can be made having one single or multiple input ends in a detoured configuration. Further, the antenna circuit 2 can be embedded in the shell body 1 (see FIG. 4). Alternatively, the antenna circuit 2 can be formed integral with the inner or outer surface of the shell body 1 in a flush manner (see FIGS. 3 and 5) or in a protruded status. The antenna circuit 2 can be made having metal contact pins 31 or metal contact springs 32 exposed to the outside of the shell body 1 for contacting the respective contacts of the circuit board 3 in the wireless communication device (see FIGS. 6 and 7).

Because the antenna circuit 2 is formed in the shell body 1, it does not occupy the surface space of the circuit board 3 of the wireless communication device, and the surface space of the circuit board 3 can be fully utilized for the arrangement of other electronic component parts without causing interference. Therefore, the design of the present invention allows diminishing the size of the wireless communication device.

Further, because the antenna circuit 2 is formed in the shell body 1, the shell body 1 well protects the antenna circuit 2 against deformation.

After installation, the contacts 21 of the antenna circuit 2 are kept in close contact with the respective contact pins 31 of the circuit board 3 (see FIG. 6) or the metal contact spring strips 32 of the circuit board 3 (see FIG. 7) in the wireless communication device.

During fabrication, the antenna circuit 2 can be formed in a ceramic substrate, polymer substrate, or ceramic polymer compound substrate and then packaged in the shell body 1 by molding or insert molding.

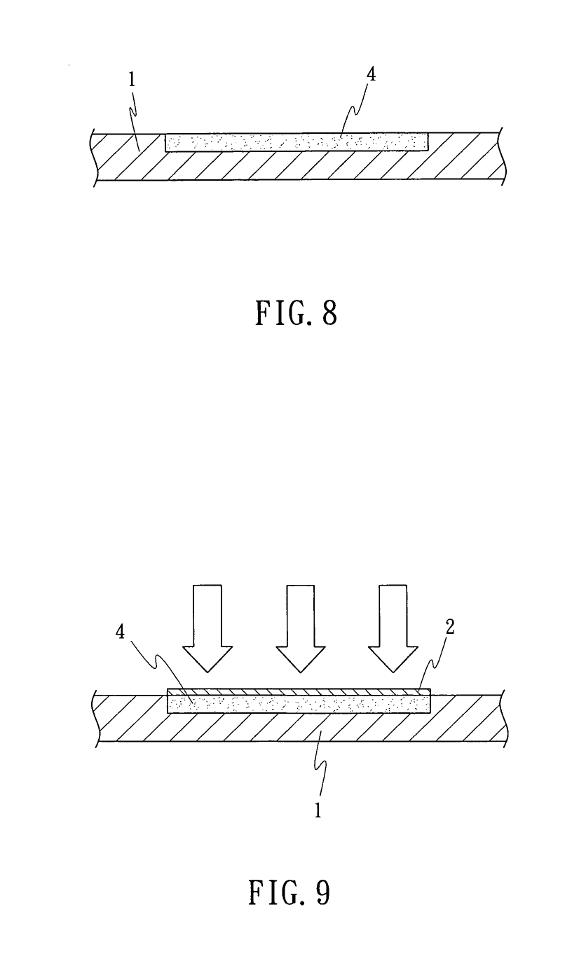

Referring to FIG. 8, an antenna circuit bonding member 4 can be directly formed in the shell body 1 out of a conducting polymer or conducting compound material in a flush manner through a secondary injection molding, screen printing, spray coating, or masking technique, and then an electroplating or electroforming process is employed to form the desired antenna circuit 2 on the antenna circuit bonding member 4 (see FIG. 9).

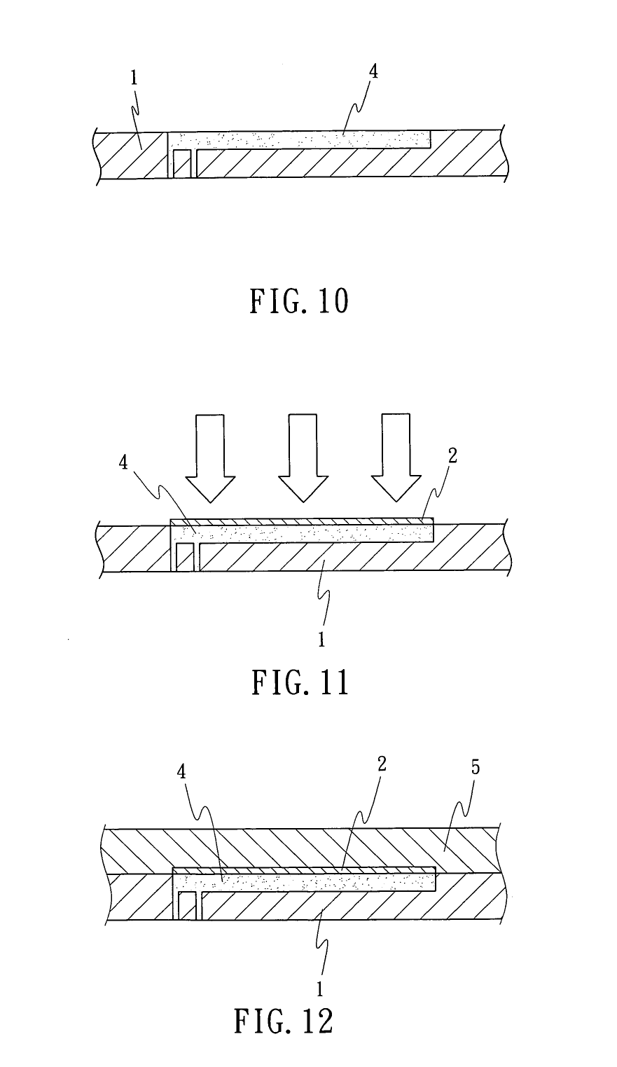

Referring to FIGS. 10-12, in still another alternate form of the present invention, an antenna circuit bonding member 4 is directly formed in the shell body 1 out of a conducting polymer or conducting compound material in a flush manner through a secondary injection molding, screen printing, spray coating, or depositing technique (See FIG. 10), and then an electroplating or electroforming process is employed to form the desired antenna circuit 2 on the antenna circuit bonding member 4 (see FIG. 11), and then a packaging layer 5 is bonded to the shell body 1 and covered over the antenna circuit 2 and the antenna circuit bonding member 4 (see FIG. 12). The packaging layer 5 is selected from a ceramic and polymer compound, or any suitable material having a specific dielectric constant.

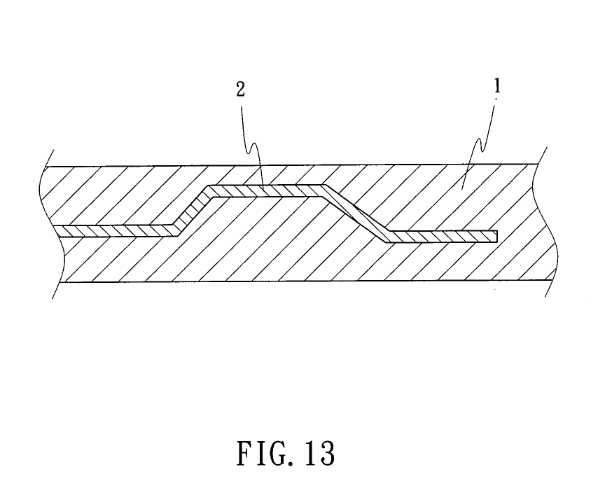

Referring to FIG. 13, the antenna circuit 2 can be made in a three-dimensional configuration and embedded in the shell body 1 to enhance the performance. Further, two or more antenna circuits 2 may be formed in the shell body 1 to fit different requirements (multiband, bandwidth, specific radiation field).

Although particular embodiment of the invention have been described in detail for purposes of illustration, various modifications and enhancements may be made without departing from the spirit and scope of the invention.

What is claimed is:

1. A device shell for use in a wireless communication device, comprising:
a shell body injection-molded from a compound material in a predetermined shape; and
at least one antenna circuit formed in said shell body and electrically connectable to a circuit board in a wireless communication device in which the device shell is used.

2. The device shell as claimed in claim 1, wherein said at least one antenna circuit each has a plurality of metal contacts exposed to the outside of said shell body for contacting respective metal contact means at a circuit board in a wireless communication device in which the device shell is used.

3. The device shell as claimed in claim 2, wherein the metal contacts of said at least one antenna circuit are metal contact pins.

4. The device shell as claimed in claim 2, wherein the metal contacts of said at least one antenna circuit are metal contact springs.

5. The device shell as claimed in claim 1, wherein said at least one antenna circuit is respectively formed in a substrate through an insert molding process and then packaged in said shell body, said substrate being made out of one of the materials of ceramics, polymers, and compounds of ceramics and polymers.

6. The device shell as claimed in claim 1, wherein said at least one antenna circuit is respectively formed in an antenna circuit bonding member through one of the processes of electroplating and electroforming, said antenna circuit bonding member being directly formed in said shell body through one of the processes of secondary molding, screen printing, spray coating, and depositing technique.

7. The device shell as claimed in claim 6, wherein said antenna circuit bonding member is directly formed in said shell body out of one of the materials of conducting polymer and conducting compound material.

8. The device shell as claimed in claim 1, which is made by:
injection molding said shell body, and then covering a layer of a conducting polymer or compound material on said shell body by printing or spray coating, and then employing an electroplating or electroforming process to said layer of conducting polymer or compound material to form said least one antenna circuit.

9. The device shell as claimed in claim 1, which is made by:
injection molding said shell body, and then forming said at least one antenna circuit in said shell body by electroplating or electroforming by means of photoresist or shielding means.

10. The device shell as claimed in claim 1, wherein said at least one antenna circuit is respectively formed in an antenna circuit bonding member through one of the processes of electroplating and electroforming, and then covered with a packaging layer, said packaging layer being selected from a compound material containing ceramics and polymer, or a material having a predetermined dielectric constant, said antenna circuit bonding member being directly formed in said shell body through one of the processes of secondary molding, screen printing, spray coating, and depositing technique.

11. The device shell as claimed in claim 1, wherein said at least one antenna circuit each has a three-dimensional configuration.
